(19) United States
(12) Patent Application Publication
(10) Pub. No.: US 2026/0006289 A1
(43) Pub. Date: Jan. 1, 2026

(54) METHOD AND APPARATUS FOR REDUCING STUTTERING

(71) Applicants: Advanced Micro Devices, Inc., Santa Clara, CA (US); ATI Technologies ULC, Markham (CA)

(72) Inventors: Gennadiy Kolesnik, Markham (CA); Rafayel Hovsepyan, Markham (CA); Lev Kisselman, Santa Clara, CA (US); Bingzheng Feng, Markham (CA)

(73) Assignees: Advanced Micro Devices, Inc., Santa Clara, CA (US); ATI Technologies ULC, Markham (CA)

(21) Appl. No.: 18/755,903

(22) Filed: Jun. 27, 2024

(51) Int. Cl. H04N 21/4402; H04N 21/442

(52) U.S. Cl. CPC H04N 21/4402; H04N 21/44209

(57) ABSTRACT

A client device receives a stream of encoded frames and decodes the frames to generate decoded frames. The frame decoding is performed in parallel with extrapolating predicted frames from the decoded frames. The client device uses the decoded frames to generate output frames and discards the predicted frames. In response to detecting an arrival delay with respect to an encoded frame, the client device uses the predicted frames to generate output frames.

### BACKGROUND

Variable or inconsistent network transmission time in video systems often results in video stutter. In cases where video frames arrive at irregular intervals, frame repeats and/or frame skips manifest themselves as noticeable video stutter, especially at lower frame rates. Stutter also occurs in audio transmissions where audio frames arrive at irregular intervals. Stutter is especially problematic in low latency streaming systems, such as cloud game streaming, where buffering is not suitable.

In typical network implementations, the amount of time needed to transmit a frame is variable and depends on a plurality of internal and external factors, such as frame size, available network throughput, and network latency. In many implementations, some of these values, such as, for example, latency, cannot be predicted or controlled by the sender or the receiver. This variance in transmission time results in frame arrival delays which may exceed the frame presentation interval at a given frame rate. For example, when a video frame does not arrive at the client in time, e.g., for the next vertical sync (Vsync) interval, the client will typically repeat the last available frame one or more time(s) and skip over one or more subsequent frame(s). When the video being streamed contains high amounts of motion, repeating the last frame and skipping subsequent frames results in a visible “freeze” of the video that degrades the quality of the streamed video.

For regular non-interactive video streaming (regular video streaming, such as, for example, YouTube), where latency is not a concern, sufficient buffering typically eliminates video stutter by accumulating several frames on the receiving end before presenting them at regular intervals. However, in low-latency streaming scenarios, such as, for example, game streaming, buffering video frames before presentation is not practical since it would increase latency. Additional techniques for reducing stutter are needed.

### BRIEF DESCRIPTION OF THE DRAWINGS

A more detailed understanding may be had from the following description, given by way of example in conjunction with the accompanying drawings wherein:

FIG. 1 is a block diagram of an example computing device in which one or more features of the disclosure can be implemented;

FIG. 2A presents a detailed view of a video encoder, according to an example;

FIG. 2B represents a decoder for decoding compressed data generated by an encoder such as the encoder of FIG. 2A, according to an example;

FIG. 3 depicts a low-latency streaming system, according to an example;

FIG. 4 is a timing diagram illustrating a case where video stutter is present, according to an example;

FIG. 5 is a timing diagram illustrating a case where video stutter occurs and a frame is dropped at the receiver, according to an example;

FIG. 6 is a block diagram of a system for reducing stutter, according to an example;

FIG. 7 is a timing diagram illustrating the operation of a system for reducing stutter, according to an example;

FIG. 8 is a timing diagram illustrating the operation of a system for reducing corruption from frame loss, according to an example;

FIG. 9 is a flow diagram of a method for selecting between decoded and extrapolated frames, in accordance with an example;

FIG. 10 is a flow diagram of a method for selecting between decoded and extrapolated frames, in accordance with a further example; and

FIG. 11 is a flow diagram of a method for reducing stutter and/or reducing corruption from frame loss, in accordance with an example.

### DETAILED DESCRIPTION

In typical low-latency streaming scenarios, video frames are displayed by a streaming client device as soon as they are received, decoded and post-processed, without any additional delay or buffering. As a result, each video frame presented by the streaming client device will be delayed by the time necessary to pre-process, encode, transmit, decode and post-process the video frame. The time to pre-process, encode, decode and post-process is typically constant. However, the time needed to transfer the encoded video frames to the client device over the communication channel is variable and, in many cases, network transmission time variations can be neither reliably predicted, nor compensated for, which results in video frames arriving with a non-constant, unpredictable delay. When video frames arrive at irregular intervals, frame repeats and/or frame skips manifest themselves as noticeable video stutter, especially at lower frame rates. When the image on a screen is updated at a fixed frame rate, stutter is exacerbated in the event of arrival delay by the display having to wait until the next update interval (e.g. Vsync) to present the next updated frame, extending the actual delay of the late frame's presentation by up to one frame period. In the meantime, the display typically repeats the last available frame, which appears to the viewer as a “frozen” image. Once the network delays return back to their regular levels, subsequent frames are skipped in order to fast-forward to the most recent available frame, which typically makes the image “freeze” even more noticeable. For free-running displays, late frames are less problematic as they are typically displayed as soon as they are decoded and post-processed, and subsequent frames need not be dropped in order to catch up with the video stream. Nonetheless, displaying video frames at intervals that are different from the intervals at which video frames were rendered or captured still makes motion appear less smooth, albeit to a lesser degree.

Techniques for reducing stutter are described herein. In some examples, a client device receives a stream of encoded video frames and decodes the frames in order to generate decoded frames. The client device extrapolates predicted frames based on the decoded frames. The client device performs the frame decoding in parallel with extrapolating the predicted frames. In some examples, the client device applies post-processing to the decoded frames to generate output frames to be sent to an output device and discards the predicted frames. In some examples, in response to detecting an arrival delay with respect to an encoded frame expected to be received by the client device, the client device applies post-processing to the predicted frames to generate output frames to be sent to the output device. In some examples, the client device discards decoded frames received during application of post-processing to the predicted frames.

In some examples, the client device resumes application of post-processing to the decoded frames to generate the output frames and resumes discarding the predicted frames in response to an encoded frame being timely received at the client device. In some examples in which an encoding scheme is used where some encoded frames are dependent upon previous frames, the client device resumes application of post-processing to the decoded frames to generate the output frames and resumes discarding the predicted frames when the encoded frame that is timely received is a frame having encoding that is not dependent on a previous encoded frame.

In some examples, the encoded frames are video frames, while in other examples the encoded frames are audio fragments.

In some examples, the client device does not buffer frames output from the post-processing before outputting the output frames to the output device.

In some examples, the stream of encoded frames received at the client device is generated by an interactive gaming application.

In some examples, the client device extrapolates predicted frames based on motion vectors derived from the decoded frames.

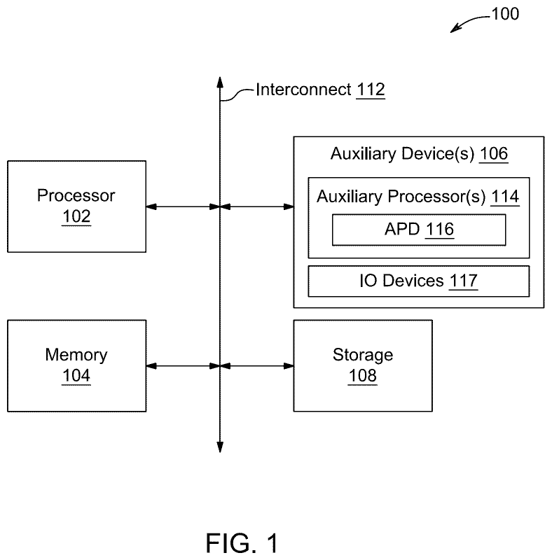

FIG. 1 is a block diagram of an example computing device 100 in which one or more features of the disclosure can be implemented. In various examples, the computing device 100 is one of, but is not limited to, for example, a computer, a gaming device, a handheld device, a set-top box, a television, a mobile phone, a tablet computer, or other computing device. The device 100 includes, without limitation, one or more processors 102, a memory 104, one or more auxiliary devices 106, and a storage 108. An interconnect 112, which can be a bus, a combination of buses, and/or any other communication component, communicatively links the one or more processors 102, the memory 104, the one or more auxiliary devices 106, and the storage 108.

In various alternatives, the one or more processors 102 include a central processing unit (CPU), a graphics processing unit (GPU), a CPU and GPU located on the same die, or one or more processor cores, wherein each processor core can be a CPU, a GPU, or a neural processor. In various alternatives, at least part of the memory 104 is located on the same die as one or more of the one or more processors 102, such as on the same chip or in an interposer arrangement, and/or at least part of the memory 104 is located separately from the one or more processors 102. The memory 104 includes a volatile or non-volatile memory, for example, random access memory (RAM), dynamic RAM, or a cache.

The storage 108 includes a fixed or removable storage, for example, without limitation, a hard disk drive, a solid state drive, an optical disk, or a flash drive. The one or more auxiliary devices 106 include, without limitation, one or more auxiliary processors 114, and/or one or more input/output (“IO”) devices. The auxiliary processors 114 include, without limitation, a processing unit capable of executing instructions, such as a central processing unit, graphics processing unit, parallel processing unit capable of performing compute shader operations in a single-instruction-multiple-data form, multimedia accelerators such as video encoding or decoding accelerators, or any other processor. Any auxiliary processor 114 is implementable as a programmable processor that executes instructions, a fixed function processor that processes data according to fixed hardware circuitry, a combination thereof, or any other type of processor.

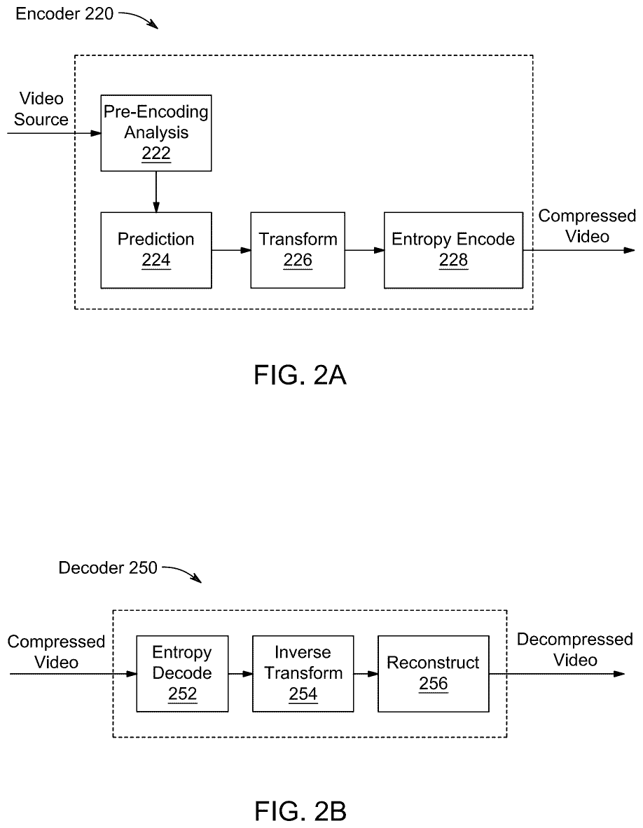

The one or more auxiliary devices 106 include a video system 115. The video system 115 includes one or both of a video encoder or a video decoder. In various examples, the video system 115 is implemented partially or fully in hardware (e.g., using circuitry such as a programmable processor and/or fixed-function circuitry), partially or fully in software executing on a processor, or as a combination there. Additional disclosure about the encoder and decoder are provided elsewhere herein, such as with reference to FIGS. 2A and 2B.

The one or more IO devices 117 include one or more input devices, such as a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals), and/or one or more output devices such as a display device, a speaker, a haptic feedback device, one or more lights, an antenna, or a network connection (e.g., a wireless local area network card for transmission and/or reception of wireless IEEE 802 signals).

FIG. 2A presents a detailed view of a video encoder 220, according to an example. The video encoder 220 accepts source video, encodes the source video to produce compressed video (or “encoded video”), and outputs the compressed video. Implementations of the encoder 220 may include blocks other than those shown. The encoder 220 includes a pre-encoding analysis block 222, a prediction block 224, a transform block 226, and an entropy encode block 228. In some alternatives, the encoder 220 implements one or more of a variety of known video encoding standards (such as MPEG2, H.264, or other standards), with the prediction block 224, transform block 226, and entropy encode block 228 performing respective portions of those standards. In other alternatives, the encoder 220 implements a video encoding technique that is not a part of any standard. In various examples, the encoder 220 includes and/or communicates with a memory that stores data for frames being encoded. The data stored includes any combination of data input by or output by the encoder 220.

The prediction block 224 performs prediction techniques to reduce the amount of information needed for a particular frame. Various prediction techniques are possible. One example of a prediction technique is a motion prediction based inter-prediction technique, where a block in the current frame is compared with different groups of pixels in a different frame until a match is found. Various techniques for finding a matching block are possible. One example is a sum of absolute differences technique, where characteristic values (such as luminance) of each pixel of the block in the current block is subtracted from characteristic values of corresponding pixels of a candidate block, and the absolute values of each such difference are added. This subtraction is performed for a number of candidate blocks in a search window. The candidate block with a score deemed to be the “best,” such as by having the lowest sum of absolute differences, is deemed to be a match. After finding a matching block, the current block is subtracted from the matching block to obtain a residual. The residual is further encoded by the transform block 526 and the entropy encode block 228 and the block is stored as the encoded residual plus the motion vector in the compressed video.

The transform block 226 performs an encoding step which is typically lossy, and converts the pixel data of the block into a compressed format. An example transform that is typically used is a discrete cosine transform (DCT). The discrete cosine transform converts the block into a sum of weighted visual patterns, where the visual patterns are distinguished by the frequency of visual variations in two different dimensions. The weights afforded to the different patterns are referred to as coefficients. These coefficients are quantized and are stored together as the data for the block. Quantization is the process of assigning one of a finite set of values to a coefficient. The total number of values that are available to define the coefficients of any particular block is defined by the quantization parameter (QP). A higher QP means that the step size between values having unity increment is greater, which means that a smaller number of values are available to define coefficients. A lower QP means that the step size is smaller, meaning that a greater number of values are available to define coefficients. A lower QP requires more bits to store, because more bits are needed for the larger number of available coefficient values, and a lower QP requires fewer bits. Visually, a higher QP is associated with less detail and a lower QP is associated with more detail. Although the concept of QP is defined herein, the term “quality value” is sometimes used herein to generally refer to a value indicating the amount of data afforded for encoding a block, and thus the visual quality with which a block is represented in the encoded video. Numerically, quality value can be thought of as a ranking. Thus, a higher quality value means that a block is afforded a lower number of bits and is thus encoded with lower quality and a lower quality value means that a block is afforded a higher number of bits and is thus encoded with higher quality. It should be understood that although quality values are described herein as a “ranking” (with a lower number meaning higher quality and a higher number meaning lower quality), it is possible for other types of quality values to be used. For example, it is possible to use quality values where a higher number means a higher quality and a lower number means a lower quality. In some situations, the term quantization parameter is used herein. Any instance of that term can be replaced with the term “quality value.”

The entropy encode block 228 performs entropy coding on the coefficients of the blocks. Entropy coding is a lossless form of compression. Examples of entropy coding include context-adaptive variable-length coding and context-based adaptive binary arithmetic coding. The entropy coded transform coefficients describing the residuals, the motion vectors, and other information such as per-block QPs are output and stored or transmitted as the encoded video.

The pre-encoding analysis block 222 performs analysis on the source video to adjust parameters used during encoding. One operation performed by the pre-encoding analysis block includes analyzing the source video to generate information for use by the rate control QP setting, which determines what QPs should be afforded to the blocks for encoding. Additional details about determining QPs for encoding blocks are provided below.

FIG. 2B represents a decoder 250 for decoding compressed data generated by an encoder such as the encoder 220, according to an example. The decoder 260 includes an entropy decoder 252, an inverse transform block 254, and a reconstruct block 256. The entropy decoder 252 converts the entropy encoded information in the compressed video, such as compressed quantized transform coefficients, into raw (non-entropy-coded) quantized transform coefficients. The inverse transform block 254 converts the quantized transform coefficients into the residuals. The reconstruct block 256 obtains the predicted block based on the motion vector and adds the residuals to the predicted block to reconstruct the block.

Note that the operations described for FIGS. 2A and 2B only represent a small subset of the operations that encoder and decoders may use.

In various examples, the encoder 220 and/or decoder 250 are implemented within the device 100. In an example, either or both of the encoder 220 and decoder 250 are any of software executing on a processor such as the processor 102 or the APD 116, hardware (e.g., circuitry) such as a processor of any type (e.g., a fixed function analog or digital processor, a programmable processor, a configurable logic array), or any other type of hardware, or a combination of software and hardware. In some examples, the device 100 (e.g., the video system 115) includes an encoder 220, a decoder 250, or both the encoder 220 and decoder 250.

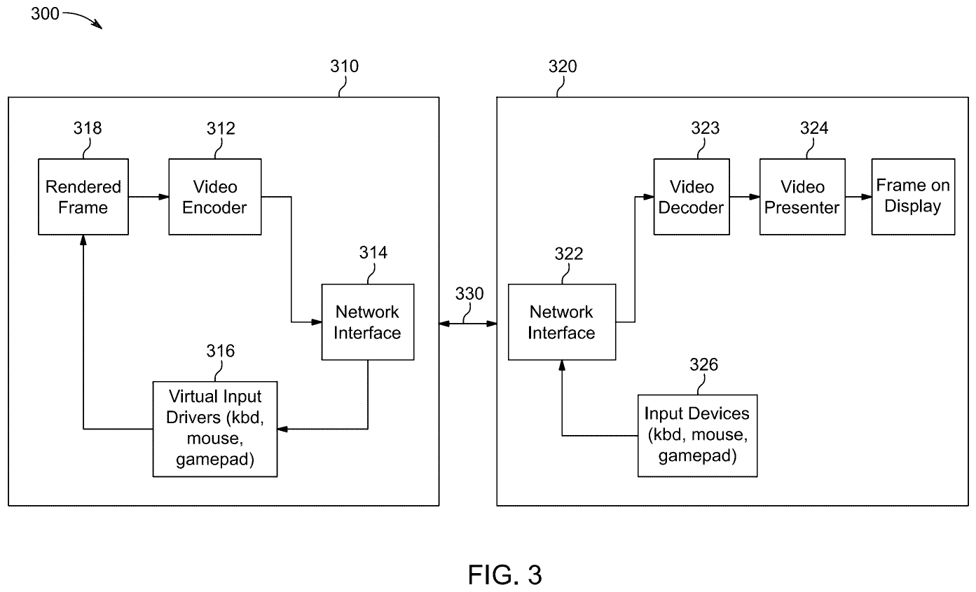

FIG. 3 depicts a typical low-latency streaming system 300, according to an example. The system includes a streaming server 310 that streams video and audio to streaming client device 320 over communication channel 330. By way of example, communication channel 330 is an Ethernet, WiFi, cellular or Bluetooth connection, a fiberoptic cable, or any other suitable medium for transmission of data between the streaming server and streaming client device. In some examples, streaming server 310 is a computer device, such as a desktop PC, a laptop, a server, a smart phone or a tablet, a video camera, etc. In some examples, streaming server 310 renders video frames; while in other examples, streaming server 310 receives frames from another attached device, such as, for example, a video camera.

In the example shown in FIG. 3, streaming server 310 includes video encoder 312 for encoding rendered frame(s) 318. Encoder 220 described in connection with FIG. 2A above is an example of encoder 312. Video encoder 312 provides frame(s) to network interface 314 for transmission over communication channel 330 to client device 320. Streaming server 310 also includes virtual input drivers 316 which correspond, for example, to a keyboard, mouse or gamepad. Output from virtual input drivers 316 is used to generated render frame(s) 318.

In a typical streaming system 300 like that shown in FIG. 3, each frame is assigned a presentation timestamp (PTS), usually relative to the beginning of the stream or some other well-known moment in time, indicating the moment when the frame was either rendered or captured. Typically, video frames are rendered/captured at regular intervals, however, some systems can render them at arbitrary points in time, depending on the complexity of the frame, server power usage, temperature, CPU and GPU load and other factors. Regardless of the regularity of the video frame intervals, the PTS reflects the time at which the frame has been obtained. At the streaming server 310, these video frames are then optionally pre-processed, encoded and compressed using a video encoder, such as, for example, H.264, HEVC, AV1, VP9, MJPEG, etc. Encoded frame(s) are then transmitted to the streaming client device 320 along with its presentation timestamp over network communication channel 330 (e.g., an IP-based network).

Streaming client device 320 receives encoded video frames via network interface 322 from streaming server 310. In some examples, streaming client device 320 decodes, post-processes and displays the decoded and post-processed video frames on an attached display at intervals determined by each frame's PTS. In the example shown, video decoder 323 at client device 320 decodes the encoded frame(s) received at the client device. Decoder 250 described in connection with FIG. 2B above is an example of decoder 323. In system 300, decoder 250 uses a video decoder compatible with video coder 312. After decoding, streaming client device 320 optionally post-processes the decoded video frames. Irrespective of whether post-processing is used, streaming client device 320 presents the frames (using video presenter 324) according to the presentation timestamp attached to each received video frame. In some applications, when video frames are being captured at specific time intervals, the frames need to be presented at the same intervals in order for the motion present in the video to be depicted on the display attached to the streaming client device 320 in the same fashion as if the display was attached directly to the streaming server 310. This statement is equally applicable to video frames rendered at either regular or irregular intervals. Client device 320 also includes input devices 326 (e.g., a keyboard, mouse or gamepad) coupled to network interface 322.

In typical low-latency streaming scenarios, video frames are displayed by streaming client device 320 as soon as they are received, decoded and post-processed, without any additional delay or buffering. As a result, each video frame presented by the streaming client device 320 will be delayed by the time necessary to pre-process, encode, transmit, decode and post-process the video frame. The time to pre-process, encode, decode and post-process is typically constant and is determined by, e.g., the capabilities of streaming server 310 and streaming client device 320, video stream resolution, color depth and/or image format. However, the time needed to transfer the encoded frames from the streaming server 310 to the client device 320 over the communication channel 330 is variable and is subject to external factors, including, but not limited to network congestion, network collisions and/or RF interference. In many cases, network transmission time variations can be neither reliably predicted, nor compensated for, which results in video frames arriving with a non-constant, unpredictable delay.

A display (not shown) connected to client device 320 displays an updated image either at regular intervals or in a free-running mode. When the image on the screen is updated at a fixed frame rate, stutter is exacerbated in the event of arrival delay, by the display having to wait until the next update interval (e.g. vsync) to present the next updated frame. This display delay extends the actual delay of the late frame's presentation by up to one frame period. In the meantime, the display typically repeats the last available frame, which appears to the viewer as a “frozen” image. Once the network delays return back to their regular levels, subsequent frames are skipped in order to fast-forward to the most recent available frame, which typically makes the image “freeze” even more noticeable. For free-running displays, late frames are less problematic as they are typically displayed as soon as they are decoded and post-processed, and subsequent frames need not be dropped in order to catch up with the video stream. Nonetheless, displaying video frames at intervals that are different from the intervals at which video frames were rendered or captured still makes motion appear less smooth, albeit to a lesser degree.

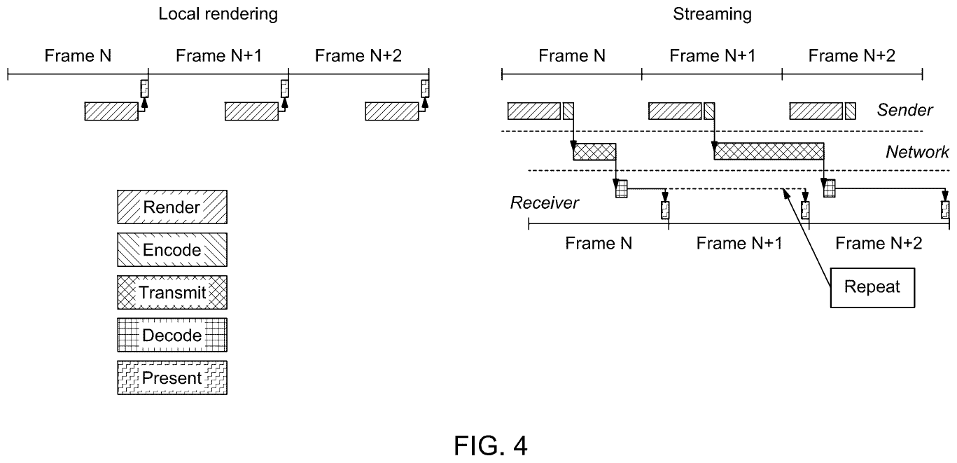

FIG. 4 is a timing diagram illustrating a case where video stutter is present, according to an example. The left side of the diagram depicts timing of local rendering and presentation of Frames N, N+1 and N+2. The right side of the diagram depicts the timing of the frames as rendered and encoded by the sender (top row), the timing of the transmission of the frames over the network (middle row) and the timing of the decoding and presentation of the frames at the receiver (bottom row). In the example of FIG. 4, the sender corresponds to streaming server 310, the network corresponds to communication channel 330 and the receiving device corresponds to client streaming device 320. As depicted in FIG. 4, the transmission time over the network for Frame N+1 is longer than that of Frame N, resulting in delayed reception of Frame N+1 at the receiver. Since Frame N+1 was not received in sufficient time to be decoded before the next presentation interval, the receiver repeats Frame N in the interval where Frame N+1 would have been displayed had it been timely received, resulting in stutter.

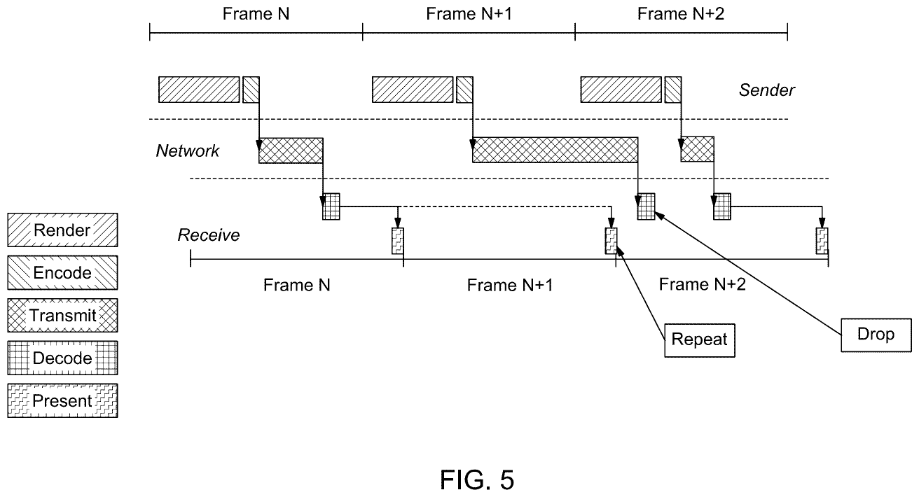

FIG. 5 is a timing diagram illustrating a case where video stutter occurs and a frame is dropped at the receiver, according to a further example. The top row of the diagram depicts the timing of the frames as rendered and encoded by the sender, the middle row depicts the timing of the transmission of the frames over the network, and the bottom row depicts the timing of the decoding and presentation of the frames at the receiver. In the example of FIG. 5, Frame N arrives at the receiver on time and is decoded and presented on the N-th Vsync. Frame N+1 arrives too late to be decoded for Vsync N+1 and, as a result, display of Frame N is repeated and Frame N+1 is scheduled for presentation at Vsync N+2. However, Frame N+2 arrives at the receiver and is decoded before Vsync N+2. In this scenario, Frame N+2 is displayed at Vsync N+2 and Frame N+1 is dropped.

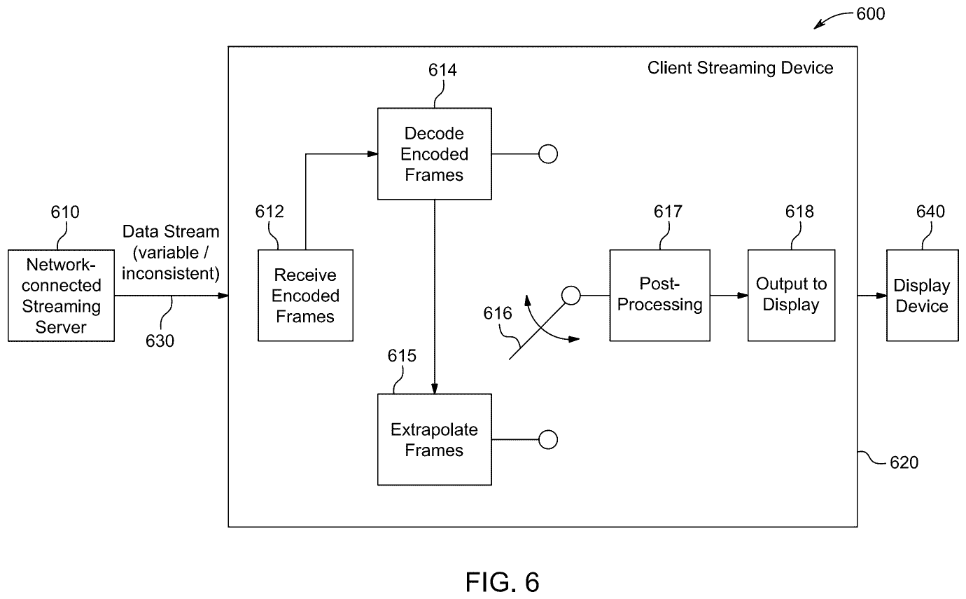

FIG. 6 is a block diagram of a system 600 for reducing stutter, according to an example. Network-connected streaming server 610 generates a video stream of encoded frames that is made variable/inconsistent by the varying latency of network 630 to the client streaming device 620. The client device receives encoded frames 612 via, e.g., a network interface. At block 614, client device 620 decodes the encoded frames in order to generate decoded frames. At block 615, the client device extrapolates predicted frames based on the decoded frames. For example, client device 620 generates the predicted frames by using motion vectors derived from the decoded frames to extrapolate predicted frames. In some examples, client streaming device 620 performs the frame decoding in parallel with performing extrapolation to generate the predicted frames, meaning that, where appropriate, and in some examples, the client streaming device 620 performs at least a portion of the frame decoding in a first time period that overlaps with a second time period in which the client streaming device 620 performs the extrapolation. Selection logic (described below) provides either a decoded frame or a predicted frame to post-processing block 617 for each frame interval, and the post-processed frames are output at block 618 to a display device 640. In some examples, the frame extrapolation uses the motion vectors of a frame to modify that frame based on the motion vectors (e.g., by offsetting the portions of the frame by an amount and direction that is determined based on the motion vectors—e.g., equal or proportional to the magnitude of the motion vectors multiplied by the frame time), in order to generate the extrapolated frame.

The selection logic 616 is responsive to, among other things, the detection of an arrival delay with respect to an encoded frame expected to be received by the client device 620. In one example, the arrival delay is such that the encoded frame arrives too late to be decoded for the next Vsync. Prior to detection of an arrival delay, selection logic 616 provides decoded frame to post-processing block 617. However, in response to detecting the arrival delay, selection logic 616 instead supplies a predicted frame to post-processing block 617. The predicted frame applied to the post-processing block is output for presentation on display device 640 at the Vsync interval that would have been used to display the delayed encoded frame had it been timely received. In some examples, client streaming device 620 discards the delayed encoded frame. In some examples, selection logic 616 resumes providing decoded frames to the post-processing stage and begins discarding predicted frames in response to an encoded frame being timely received at the client device.

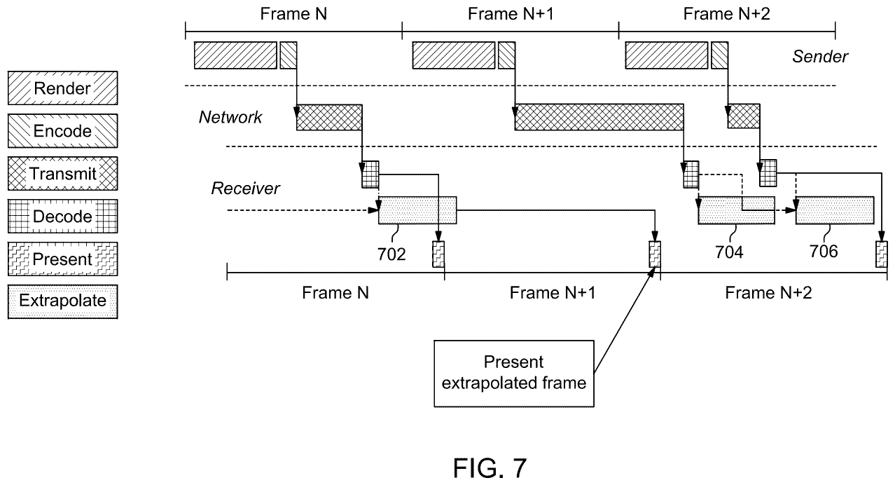

FIG. 7 is a timing diagram illustrating the operation of system 600 for reducing stutter, according to an example. The top row of the diagram depicts the timing of the frames as rendered and encoded by streaming server 610, the middle row depicts the timing of the transmission of the frames over the network 630, and the bottom row depicts the timing of the decoding and presentation of the frames at the client streaming device 620. In the example of FIG. 7, when Frame N arrives at the client streaming device 620, Frame N is decoded and then used to extrapolate predicted frame 702. In the example, Frame N arrives at the client streaming device 620 in time to be decoded and post-processed before the next Vsync. Accordingly, selection logic 616 directs the decoded frame corresponding to Frame N to the post-processing operation, and the post-processed decoded frame is presented at the next Vsync. Continuing with the example, Frame N+1 is delayed and not received by the client streaming device 620 in time to be decoded, post-processed and presented before the next Vsync. Accordingly, selection logic 616 directs the previously predicted frame 702 to the post-processing operation, and the post-processed predicted frame is presented at the next Vsync. Continuing with the example, after predicted frame 702 is presented, Frame N+1 is received and decoded by the client streaming device 620, and decoded Frame N+1 is used to extrapolate a subsequent predicted frame 704. Subsequent to the arrival of Frame N+1, but before the next Vsync, Frame N+2 is received by the client streaming device 620 and decoded. Decoded Frame N+2 is used to extrapolate the next predicted frame 706. In some examples, decoded Frame N+1 and decoded Frame N+2 are used to extrapolate predicted frame 706. In the example of FIG. 7, Frame N+2 arrives at the client streaming device 620 in time to be decoded and post-processed before the next Vsync. Accordingly, selection logic 616 directs the decoded frame corresponding to Frame N+2 to the post-processing operation, and the post-processed decoded frame is presented at the next Vsync. In some examples, predicted frame 704 is discarded. In a general case, depending on the prediction/extrapolation algorithm used, any number of frames can be used for extrapolation, not just N+1 and N+2. In the example above, prediction was limited only for the sake of simplicity. The number of previous frame used for extrapolation will depend on the extrapolation algorithm being used and/or hardware capabilities of the streaming client (the amount of free memory, processing power, etc.) The maximum number of sequentially predicted frames varies depending on the prediction algorithm, the number of predicted vs real frames in the history and other factors.

In video encoding, a key frame, also known as an intra-frame or I-frame, is a frame that is encoded independently of any other frames. Unlike other frames, which are encoded differentially from preceding frames (e.g., using motion vectors to describe changes), a key frame is encoded based solely on the information within that frame itself. Key frames serve as reference points for decoding other frames in the video sequence. Key frames contain the complete information necessary to display the image accurately, without requiring reference to any other frames.

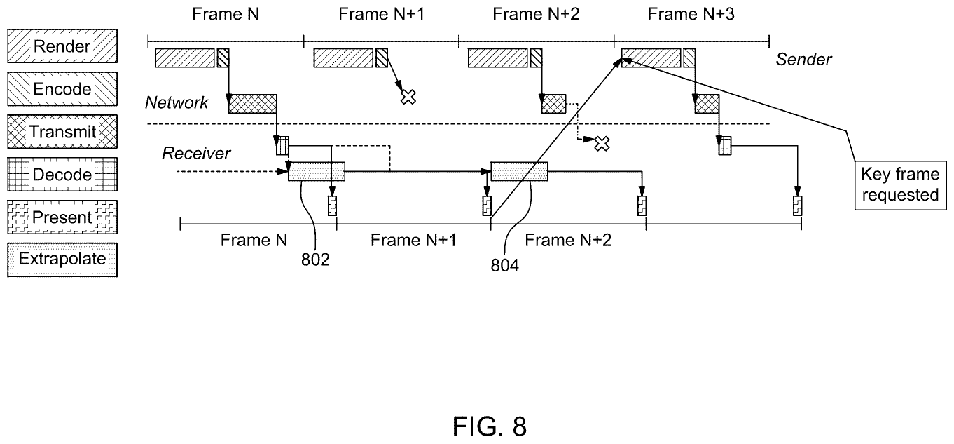

FIG. 8 is a timing diagram illustrating the operation of a system for reducing corruption from frame loss and/or stutter, according to an example. In the example of FIG. 8, the sequence of encoded frames includes key frames and frames encoded differentially from preceding frames. The top row of the diagram depicts the timing of the frames as rendered and encoded by streaming server 610, the middle row depicts the timing of the transmission of the frames over the network 630, and the bottom row depicts the timing of the decoding and presentation of the frames at the client streaming device 620. In the example of FIG. 8, when Frame N arrives at the client streaming device 620, Frame N is decoded and then used to extrapolate predicted frame 802. In the example, Frame N arrives at the client streaming device 620 in time to be decoded and post-processed before the next Vsync. Accordingly, selection logic 616 directs the decoded frame corresponding to Frame N to the post-processing operation, and the post-processed decoded frame is presented at the next Vsync. Continuing with the example, Frame N+1 is lost in transmission over the communication channel and is not received by the client streaming device 620. Responsive to detecting that Frame N+1 has not arrived in time to be decoded for the next Vsync, selection logic 616 directs the previously predicted frame 802 to the post-processing operation, and the post-processed predicted frame is presented at the next Vsync. Continuing with the example, after predicted frame 702 is presented, the receiver (e.g., client streaming device 620) sends a message to the sender (e.g., streaming server 610) requesting transmission of a key frame. Next, the client streaming device 620 extrapolates a further predicted frame 804 using, e.g., motion vectors derived from previous decoded frames. Encoded Frame N+2 (which is not a key frame) is received at the client streaming device 620 prior to the next Vsync; however, client streaming device 620 is unable to decode Frame N+2 due to the loss of Frame N+1. Responsive to detecting that Frame N+2 cannot be decoded, selection logic 616 directs the previously predicted frame 804 to the post-processing operation, and the post-processed predicted frame is presented at the next Vsync. Next, Frame N+3 (the requested key frame) arrives at the client streaming device 620 in time to be decoded and post-processed before the next Vsync. Accordingly, selection logic 616 directs the decoded frame corresponding to Frame N+3 to post-processing, and the post-processed decoded frame is presented at the next Vsync.

In some examples, motion vectors derived from previously decoded frames are used to extrapolate predicted frames. Motion vectors are used in video compression for motion compensation, which involves analysis of the content of a frame based on its neighboring frames. Typically, this process estimates the appearance of a frame by leveraging the motion information from adjacent frames. In connection with predicting frames, examples of systems disclosed herein calculate motion vectors by comparing blocks of pixels between a current decoded frame and one or more reference decoded frames (preceding frames). This comparison determines how much each block has moved or changed between frames. Once motion vectors are obtained, motion prediction is performed by extrapolating the motion vectors to generate one or more predicted (future) frames. In cases where extrapolation of motion vectors indicates partial motion (e.g., a block has moved only a fraction of the block size), interpolation techniques are used to estimate the pixel values for the displaced blocks. It will be understood that any suitable extrapolation method which does not involve frame delays is applicable to the systems disclosed herein for reducing stutter and frame loss. For example, in some implementations, a predictive frame rate conversion (FRC) algorithm utilizing motion vectors is used to extrapolate the next frames. In other implementations, a machine-learning (ML) based extrapolation algorithm is used. In some examples, the extrapolation algorithm is selected based on functional and performance requirements that include: being truly predictive in extrapolating at least one future frame, rather than filling the gaps between previous frames, and being able to extrapolate at least one future frame within one frame interval. In some examples, shaders and other GPU features are utilized for frame extrapolation, as the streaming client device's GPU usually sees low loads.

As explained above, as encoded video frames are being received and decoded by the streaming client device, the streaming client device extrapolates one or more future frames using previously received (and decoded) frames. In some examples, future video frames are extrapolated for predefined time intervals relative to the current frame's PTS based on the current frame rate calculated using presentation timestamps of several previous frames. This is possible because presentation timestamps of a continuous video stream increment monotonously. For example, when the last several frames had a presentation timestamp delta of 16.6 ms, future frames are extrapolated to 16.6, 33.3 ms and so on, into the future, relative to the PTS of the most recently received frame. In some examples, this extrapolation runs continuously using a series of previously decoded and/or extrapolated frames as a basis for predicting future frames that have not yet been received by the streaming client device. In some examples, should the next video frame be received, decoded and post-processed in time to be presented at the expected time, defined by its PTS, the corresponding extrapolated frame is discarded and the received and decoded frame is presented normally. However, when the next video frame is delayed during transmission over the network and cannot be decoded and post-processed in time to be presented at the expected time defined by its presentation timestamp, the corresponding predicted (extrapolated) frame is presented instead and the actual frame, if ever received, is discarded. In some examples, late video frames, even if not presented, are still be used for extrapolation of the subsequent frames, provided that they arrive in time.

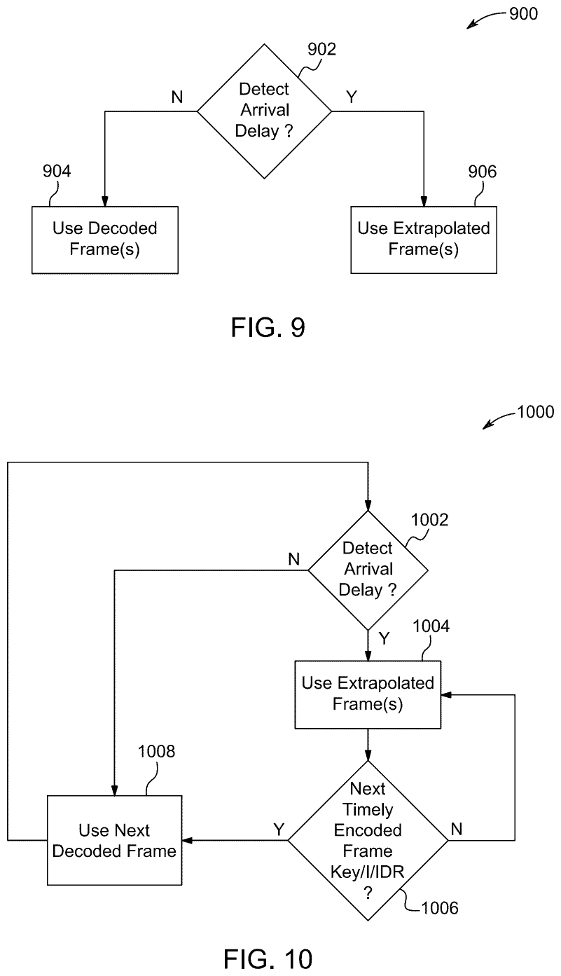

FIG. 9 is a flow diagram of a method 900 implemented by selection logic 616 for selecting between decoded and extrapolated (predicted) frames, in accordance with an example. In some examples, method 900 is applicable where differential encoding is not used for encoding the video sequence. At block 902, the selection logic 616 detects whether an arrival delay has occurred with respect to an encoded frame expected to be received by the client device 620. In one example, the arrival delay is such that the encoded frame arrives too late to be decoded for the next Vsync. If no arrival delay is detected, in block 904 the selection logic provides the next decoded frame to the post-processing operation. If an arrival delay is detected, in block 906 the selection logic provides the previously predicted frame to the post-processing operation.

FIG. 10 is a flow diagram of a method 1000 for selecting between decoded and extrapolated frames, in accordance with a further example. In some examples, method 1000 is applicable where differential encoding is used for encoding the video sequence. At block 1002, the selection logic 616 detects whether an arrival delay has occurred with respect to an encoded frame expected to be received by the client device 620. For example, the arrival delay is such that the encoded frame arrives too late to be decoded for the next Vsync. If no arrival delay is detected, in block 1008 the selection logic provides the next decoded frame to the post-processing operation. If an arrival delay is detected, in block 1004 the selection logic provides the previously predicted frame to the post-processing operation. At block 1006, the selection logic identifies whether a subsequent encoded key frame has been timely received by the streaming client device. If no such encoded key frame was received, the selection logic 616 provides the next predicted frame to the post-processing operation in block 1004. If, however, such an encoded key frame was timely received, the selection logic 616 provides the next decoded frame to the post-processing operation in block 1008.

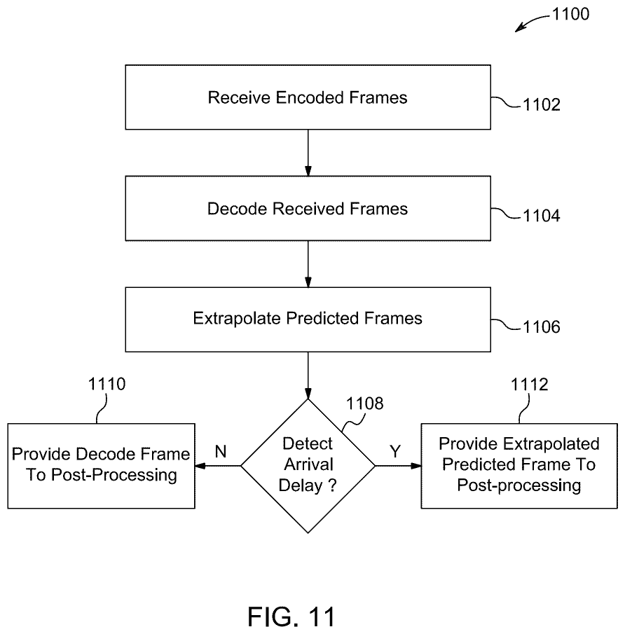

FIG. 11 is a flow diagram of a method 1100 for reducing stutter and/or reducing corruption from frame loss, in accordance with an example.

In step 1102, a client device receives a stream of encoded frames. In some examples, the client device includes input devices such as a keyboard, mouse or gamepad, and the client device is coupled to a network using a network interface. In some examples, the stream of encoded frames have been encoded using differential encoding, while in other examples differential encoding is not used. The encoded frames correspond, for example, to encoded video or audio frames. In some examples, each encoded frame has a presentation timestamp. In some examples, the stream of encoded frames received at the client device is generated by an interactive gaming application.

In step 1104, the client device decodes the received frames in order to generate decoded frames. The decoding operation is the inverse of the encoding operation used to generate the received frames. In some examples, the decoder operates to decode frames in accordance with one or more of the following formats: H.264, HEVC, AV1, VP9, MJPEG, etc.

In step 1106, the client device extrapolates predicted frames based on one or more decoded frames. The client device performs the frame decoding in parallel with extrapolating the predicted frames. In some implementations, the client device extrapolates predicted frames based on motion vectors derived from the decoded frames.

In step 1108, the client device detects whether an arrival delay has occurred with respect to an encoded frame expected to be received by the client device. In one example, the arrival delay is such that the encoded frame arrives too late to be decoded for the next Vsync. If no arrival delay is detected, in block 1110 the next decoded frame is provided to the post-processing operation. If an arrival delay is detected, in block 1112 the previously predicted frame is provided to the post-processing operation. In some examples, the client device resumes providing decoded frames to the post-processing operation and discards predicted frames in response to an encoded frame being timely received at the client device. In some such examples, the client device resumes application of post-processing to the decoded frames to generate the output frames and discarding the predicted frames when the encoded frame that is timely received is a frame having encoding that is not dependent on a previous encoded frame.

In some implementations, the client device does not buffer frames output from the post-processing operation before outputting the output frames to a display device.

The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements aspects of the embodiments.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

1. A method comprising:
receiving a stream of encoded frames at a client device;
decoding the encoded frames at the client device to generate decoded frames;
extrapolating, in parallel with the decoding, predicted frames based on the decoded frames;
generating, from the decoded frames, output frames to be sent to an output device and discarding the predicted frames;
detecting an arrival delay for a next encoded frame expected to be received by the client device; and
in response to a future encoded frame lacking a sufficient time budget, generating, from the predicted frames, replacement output frames to be sent to the output device instead of the output frames, wherein the future encoded frame lacks the sufficient time budget when the arrival delay indicates that the future encoded frame lacks time to be decoded and post-processed for presentation at its next presentation timestamp or at its vertical-sync interval.

2. The method of claim 1, wherein:
the generating, from the decoded frames, the output frames to be sent to the output device comprises applying post-processing to the decoded frames to generate the output frames;
the generating, from the predicted frames, the replacement output frames to be sent to the output device comprises applying a same post-processing to the predicted frames to generate the output frames; and
the method further comprises resuming application of post-processing to the decoded frames to generate the output frames to be sent to the output device and discarding the predicted frames when an encoded frame is timely received at the client device.

3. The method of claim 2, wherein the encoded frame that is timely received is an intra-coded (key) frame.

4. The method of claim 3, further comprising discarding differentially coded encoded frames received at the client device while the replacement output frames are being presented.

5. The method of claim 1, wherein the encoded frames are video frames.

6. (Canceled.)

7. The method of claim 2, wherein the frames output from post-processing are provided directly to the output device for immediate presentation without buffering beyond a single presentation frame slot.

8. The method of claim 1, wherein the stream of the encoded frames received at the client device is generated by an interactive gaming application and the generating of the replacement output frames does not increase end-to-end latency relative to a baseline pipeline that decodes and presents frames without a client-side post-processing-to-output buffer.

9. The method of claim 1, wherein the predicted frames are extrapolated based on motion vectors derived at the client device from the decoded frames without server assistance.

10. A system comprising:
a memory; and
one or more processors that are communicatively coupled to the memory, wherein the one or more processors are collectively configured to:
receive a stream of encoded frames at a client device;
decode the encoded frames at the client device to generate decoded frames;
extrapolate predicted frames based on the decoded frames, wherein the decoded frames are decoded and the predicted frames are extrapolated decoding and extrapolating are performed in parallel;
generate, from the decoded frames, output frames to be sent to an output device and discard the predicted frames;
detect an arrival delay for a next encoded frame expected to be received by the client device; and
in response to a future encoded frame lacking a sufficient time budget generate, from the predicted frames, replacement output frames to be sent to the output device instead of the output frames, wherein the future encoded frame lacks the sufficient time budget when the arrival delay indicates that the future encoded frame lacks time to be decoded and post-processed for presentation at its next presentation timestamp or at its vertical-sync interval.

11. The system of claim 10, wherein:
the output frames to be sent to the output device are generated by applying post-processing to the decoded frames;
the replacement output frames to be sent to the output device are generated by applying a same post-processing to the predicted frames; and
the one or more processors are further collectively configured to: resume application of post-processing to the decoded frames to generate output frames to be sent to the output device and discard the predicted frames when an encoded frame is timely received at the client device.

12. The system of claim 11, wherein the encoded frame that is timely received is an intra-coded (key) frame.

13. The system of claim 12, wherein the one or more processors are further collectively configured to discard differentially coded encoded frames received at the client device while the replacement frames are being presented.

14. The system of claim 10, wherein the encoded frames are video frames.

15. (Canceled.)

16. The system of claim 11, wherein the frames output from post-processing are provided directly to the output device for immediate presentation without buffering beyond a single presentation frame slot.

17. The system of claim 10, wherein the stream of the encoded frames received at the client device is generated by an interactive gaming application and the replacement output frames are generated without increasing end-to-end latency relative to a baseline pipeline that decodes and presents frames without a client-side post-processing-to-output buffer.

18. The system of claim 10, wherein the one or more processors are further collectively configured to extrapolate the predicted frames based on motion vectors derived at the client device from the decoded frames without server assistance.

19. A non-transitory computer-readable medium storing instructions that, when executed by a processor, cause the processor to perform operations comprising:
receiving a stream of encoded frames at a client device;
decoding the encoded frames at the client device to generate decoded frames;
extrapolating, in parallel with the decoding, predicted frames based on the decoded frames;
generating, from the decoded frames, output frames to be sent to an output device and discarding the predicted frames;
detecting an arrival delay for a next encoded frame expected to be received by the client device; and
in response to a future encoded frame lacking a sufficient time budget, generating, from the predicted frames, replacement output frames to be sent to the output device instead of the output frames, wherein the future encoded frame lacks the sufficient time budget when the arrival delay indicates that the future encoded frame lacks time to be decoded and post-processed for presentation at its next presentation timestamp or at its vertical-sync interval.

20. The non-transitory computer-readable medium of claim 19, wherein:
the generating, from the decoded frames, the output frames to be sent to the output device is performed by applying post-processing to the decoded frames;
the generating from the predicted frames, the replacement output frames to be sent to the output device is performed by applying a same post-processing to the predicted frames; and
the operations further include resuming application of post-processing to the decoded frames to generate output frames to be sent to the output device and discarding the predicted frames when an encoded frame is timely received at the client device.

21. The method of claim 1, wherein the client device continuously generates the predicted frames at presentation timestamps computed from a running estimate of frame-to-frame presentation-timestamp deltas of previously decoded frames and discards an already-generated predicted frame if a corresponding decoded frame becomes available in time.

22. The method of claim 1, further comprising transmitting a key-frame request and, while awaiting a timely intra-coded frame, discarding differentially-coded encoded frames received at the client device.
